(19) United States
(12) Patent Application Publication
(10) Pub. No.: US 2016/0180632 A1
(43) Pub. Date: Jun. 23, 2016

(54) Method for Renting a Portable and Universal Power Charger from a Vending Machine

(71) Applicants: Alejandro Santana, Doral, FL (US); Marino Polito, Doral, FL (US)

(72) Inventors: Alejandro Santana, Doral, FL (US); Marino Polito, Doral, FL (US)

(21) Appl. No.: 14/576,466

(22) Filed: Dec. 19, 2014

(51) Int. Cl. G07F 17/00; G07F 9/00; G06Q 30/06; H02J 7/00

(52) U.S. Cl. CPC G07F 17/0042; H02J 7/0047; H02J 7/0045; H02J 7/0052; G07F 9/006; G06Q 30/0645; H02J 2007/005

(57) ABSTRACT

A method for renting a portable and universal power charger from a vending machine. The method provides at least one vending machine that dispenses a power charger. The dispensed power charger is generally small, portable, and carries sufficient power to provide multiple charges to the communication device. The power charger is also configured to charge a variety of different styles and sizes of communication devices. A user may rent the portable power charger for a predetermined period and then return the power charger after it is depleted. The rented power charger is portable and contains a full store of power, such that the user may fully recharge the communication device at least one time while traveling, at work, or at a public event.

### BACKGROUND

Typically, a vending machine is a machine that dispenses items such as snacks, beverages, alcohol, cigarettes, lottery tickets, cologne, consumer products, and even gold and gems to customers automatically, after the customer inserts currency or credit into the machine. The vending machine is generally portable and has sufficient technological attributes so that it can be computerized. The inventor had used vending machines throughout his life, and recognized the easy access and portability of vending machines. This allowed the inventor to envision other items that could efficiently be carried by vending machines at multiple site.

The inventor used a wide variety of portable communication devices, such as smart phones, laptops, tablets, and computers. These communication devices, generally relied on a small battery that integrated into the communication device. However, the inventor often suffered the ignominy of a dead phone. The inventor was often left with a blank screen on the commute home or while on vacation that left him without use of the phone or laptop. Sometimes, a phone alarm didn't go off because the inventor forgot to plug it in that night. These problems seemed universal to the inventor.

Through general observation, the inventor realized that portable personal communications technology had expanded to a large segment of the world's population. Evidence of this was found in the widespread use of cellular phones, pagers, tablets, and portable computers. Also, the inventor recognized that there was an increasing demand for advanced power sources and associated technologies. One problem, which the inventor saw was the need for accessible recharging capability for the large amount and types of communication devices.

The inventor was aware that some communications device users would carry spare fully charged batteries whenever they expect to be away from wired communications for an extended period because it would be an inconvenience to carry a battery charger and wait for a battery pack to be recharged. However, despite the simplicity of this solution, there were many users who often find themselves with a depleted battery pack. Having a spare battery pack could resolve their dilemma, but the cost of purchasing an additional battery pack was often prohibitive. The inventor also noticed that the user may have not planned adequately, and did not bring a spare battery pack.

The inventor recognized that a solution to this dilemma should involve convenient access to either recharged batteries, a battery charger, or a combination of both. The inventor attempted to design a method for selling fully charged rechargeable batteries in airports, hotels, and shopping centers. But in this method, the customer would still have to pay the full price of the battery pack. And, where battery chargers were located in such places, the customer would only have to pay for the energy to recharge the battery pack, and an access fee for the battery. Additionally, the customer would have to be willing to wait at the recharging site for the battery pack to be recharged.

The inventor then modified the method by providing a battery pack exchange for communication devices. The inventor realized that an exchange that was unmanned would be more economical than a manned exchange. The inventor decided to try the method with vending machines. Initially, the customer gives up their spent battery pack, and providing it is in usable condition, receives a fully charged battery pack for a small fee or free.

The inventor realized that it would be a simple task to start such an exchange, but the slim profit margins would significantly deter a manned type of business. The inventor then modified the method to make accessing the battery pack follow a rental model. Through trial and error, the inventor designed the method, such that a user would pay an initial access fee to access the battery from a vending machine for a predetermined period, such as a few days. Upon returning the depleted battery to the vending machine, the user could obtain a fresh battery, or simply terminate the rental. The user would pay a periodic fee for each day or hour the battery was rented.

The inventor recognized that travelers could especially benefit from such a rental model. However, the travelers would often need to rent the battery at a first site, and return it at a second site. The inventor decided to enable the vending machines to communicate with each other. The inventor also integrated a central processor to coordinate access and return of the battery to different sites, and perform more sophisticated functions, generally not possible with a vending machine, such as data storage, billing, marketing, and inventory control.

Vending machines have been used for economically and efficiently dispensing items in the past, yet none with the present characteristics of the present invention. See Patent numbers: CN202838522; U.S. Pat. No. 3,800,932; and U.S. Pat. No. 5,971,205.

For the foregoing reasons, there is a need for a system and method for renting portable power chargers for communication devices that rents a portable and universal power charger for a communication device from a vending machine or from a dispenser or a power station that is controlled by an establishment.

### SUMMARY

The present invention describes a method for renting a portable and universal power charger from a vending machine. The method may provide at least one vending machine that dispenses a power charger. The dispensed power charger is generally small, portable, and carries sufficient power to provide multiple charges to the communication device. The power charger is also configured with multiple ports, cables, and plugs to charge a variety of different styles and sizes of communication devices.

In some embodiments, a renter may rent the portable power charger for a predetermined period and then return the power charger after it is depleted. The rented power charger is portable and contains a full store of power, such that the renter may fully recharge the communication device at least one time while traveling, at work, or at a public event. Those skilled in the art will recognize that such places may not have easily accessible charging stations. The method, thus provides at least one convenient and easy to use vending machine that can be accessed for renting and later returning a power charger that can be carried over distances and is adaptable to different types of communication devices.

The at least one vending machine may be integrated into public sites where the power source for the communication devices depletes and recharging stations are difficult to find. These public sites may include, without limitation, airports, bus stations, hotels, restaurants, grocery stores, parks, camp grounds, and sites that host public events. In some embodiments, the method may utilize more than one vending machine at more than one site. A plurality of vending machines are operatively connected together, such that the power charger can be rented by the user at a first vending machine, and then returned or replaced at a second vending machine. This is possible because the first and second vending machines are in communication with each other and a central processor that records the rental information, such as the renter's contact information, payment method, time of rental, and time of return. This multisite renting capacity can especially be useful for travelers moving between airports and train stations.

In some embodiments, the power charger is generally adaptable to recharge an eclectic assortment of communication devices. The power charger may include multiple USB ports, a power level indicator, and a tethering cable having multiple heads for mating with the wide variety of ports and tethering cables commonly found in communication devices. In this manner, the power charger provides a one size fits all style of accommodation. Possible communication devices that the power charger can provide power to may include, without limitation, a cell phone, a smart phone, a laptop, a computer, a tablet, a walkie-talkie, a radio, a musical instrument, and DJ equipment.

The power charger may have a power charger connector for coupling to the vending machine. The renter detaches the power charger connector from a vending machine connector to rent the power charger, and, upon returning the power charger, mates the power charger connector to the vending machine connector. The vending machine automatically recharges the power charger while the power charger connector is coupled thereto. However, the intent of the present invention is not to rent a single type of power charger. Though doing so would reduce production costs.

In some embodiments, the renter may rent the power charger for a predetermined period and then return the depleted power charger at any point after charging the communication device. The renter pays an access fee for initially accessing the power charger. The power charger may be configured to provide multiple charges to the communication device. For example, a power charger that has provided multiple charges to the communication device is depleted after four days. After the power charger is depleted, the renter either returns the depleted power charger to the vending machine for a fresh power charger, or the renter simply terminates the rental by returning the power charger to any vending machine. In either case, the renter pays a periodic fee for each interval of time that the power charger is retained. The renter pays an access fee each time an additional power charger is rented. In some embodiments, a deposit for the power charger may also be required. The renter may pay the fees with cash, credit card, or wire transfer, or any known method of payment to a vending machine.

A central processor communicates with the vending machines in different sites and performs more sophisticated functions, generally not possible with a vending machine, such as data storage, billing, marketing, and inventory control. In one alternative embodiment, the renter registers to open an account with the central processor. Upon needing a power charger, the renter simply activates the account to receive the power charger from the vending machine. And the vending machine, in communication with the central processor, deducts from the renter's account accordingly.

One objective of the present invention is to provide a portable power charger that is easily accessible for rental and return at multiple vending machines.

Another objective is to provide a power charger with multiple ports, cables, and plugs for mating and charging variously sized and styled communication devices.

Another objective is to provide easy payment options for renting the power charger.

Yet another objective is to control billing, inventory, and renting from multiple vending machines through a central processor.

Yet another objective is to generate revenue with the access fee and the periodic fee.

Yet another objective is to provide an inexpensive to implement method that is adaptable across any region of the world.

### DRAWINGS

These and other features, aspects, and advantages of the present invention will become better understood with regard to the following description, appended claims, and drawings where:

FIGS. 1A and 1B are flowchart diagrams of an exemplary method for renting a portable and universal power charger from a vending machine;

FIG. 2 is a sectioned perspective view of an exemplary vending machine containing power chargers;

FIG. 3 is a perspective view of an exemplary power charger having a plurality of ports and cables for charging different types of communication devices; and

FIG. 4 a block diagram depicting an exemplary client/server system which may be used by an exemplary web-enabled/networked embodiment of the present invention.

### DESCRIPTION

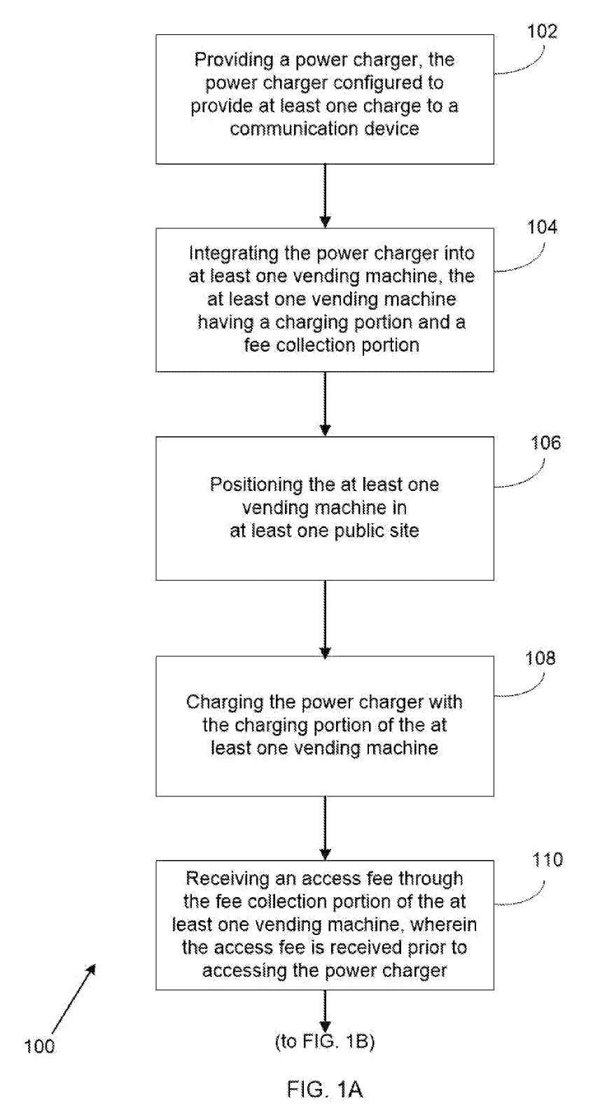

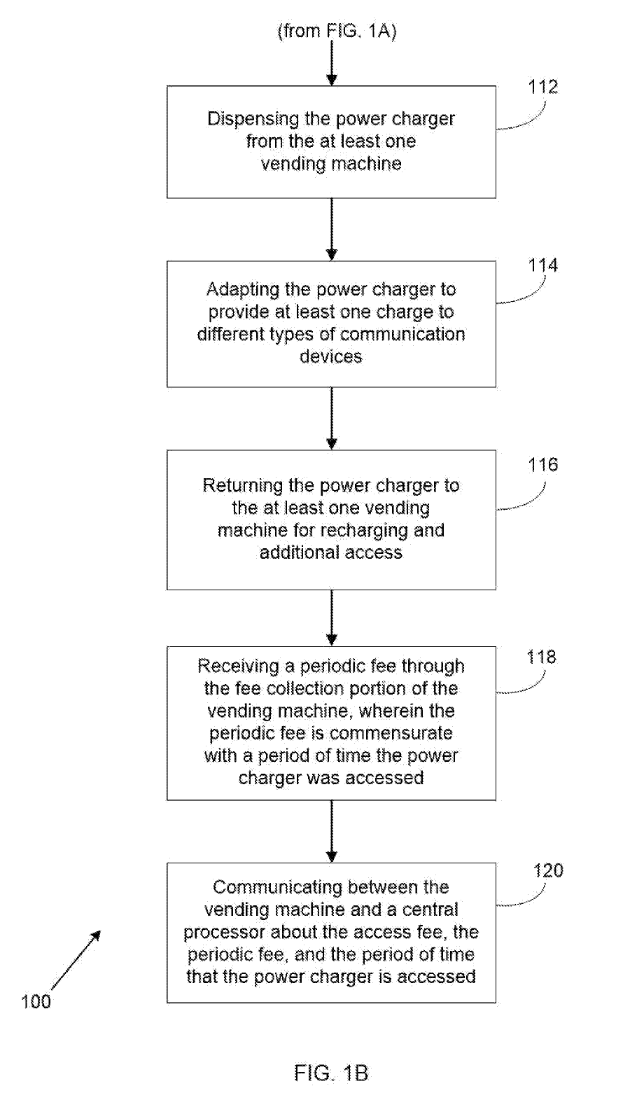

One embodiment, referenced in FIGS. 1-4, illustrates a method 100 for renting a portable and universal power charger from a vending machine. The method 100 may provide at least one vending machine 200 that dispenses a power charger 202. The dispensed power charger 202 is generally small, portable, and carries sufficient power to provide at least one charge to a communication device 232. The power charger 202 is universal, and thus has multiple ports, cables, and plugs to mate with and charge a variously sized and styles communication devices 232.

In some embodiments, a renter may rent the portable power charger 202 for a predetermined period and then return the power charger 202 after it is depleted. The rented power charger 202 is portable and contains a full store of power, such that the renter can fully recharge the communication device 232 at least one time while traveling, at work, or at a public event. Those skilled in the art will recognize that such places may not have easily accessible charging stations. The method 100, thus provides at least one convenient and easy to use vending machine 200 that can be accessed for renting and later returning the power charger 202, and that can be carried over distances, and is adaptable to different types of communication devices 232.

FIGS. 1A and 1B illustrate a flowchart diagram of an exemplary method 100 for renting a universal and portable power charger from a vending machine. The method 100 may include an initial Step 102 of providing a power charger 202, the power charger 202 configured to provide at least one charge to a communication device 232. The power charger 202 is defined by a battery and a power charger connector 222. The battery in the power charger 202 stores sufficient electrical charge to provide at least one charge to the communication device 232. In one embodiment, the battery has a capacity of at least 10,000 milliamps per hour. The power charger connector 222 mates with a vending machine connector (not shown) in the vending machine to recharge when not being rented.

In some embodiments, the power charger 202 is generally adaptable to recharge an eclectic assortment of communication devices 232 through a plurality of ports and cable 226. The ports and cables may include, without limitation, multiple USB ports, a micro USB port, a power level indicator, and a tethering cable 226 having multiple heads for mating with the wide variety of device ports and device cables commonly found in communication devices 232. However, in other embodiments, any connector that carries electrical power may be used by the power charger 202. The power charger may also include a power level indicator (not shown) to indicate the amount of power remaining. The power level indicator may include an illuminating set of bars that indicate the percentage of power left in the power charger 202. In this manner, a renter is made aware of the power and can rent another power charger 202 if needed.

The plurality of ports and cords on the power charger 202 allows for a one size fits all style accommodation with a variety of communication devices 232. Possible communication devices 232 that the power charger 202 can provide power to may include, without limitation, a cell phone, a smart phone, a laptop, a computer, a tablet, a walkie-talkie, a radio, a musical instrument, and DJ equipment. However, in other embodiments, the power charger 202 may be used in conjunction with a vehicle 234 to provide at least one charge to the communication device 232. The power charger 202 could also serve as a tether between a communication device 232 and a vehicle 234 or an external power source. In any case, the power charger 202 is generally portable and easy to carry in discretion.

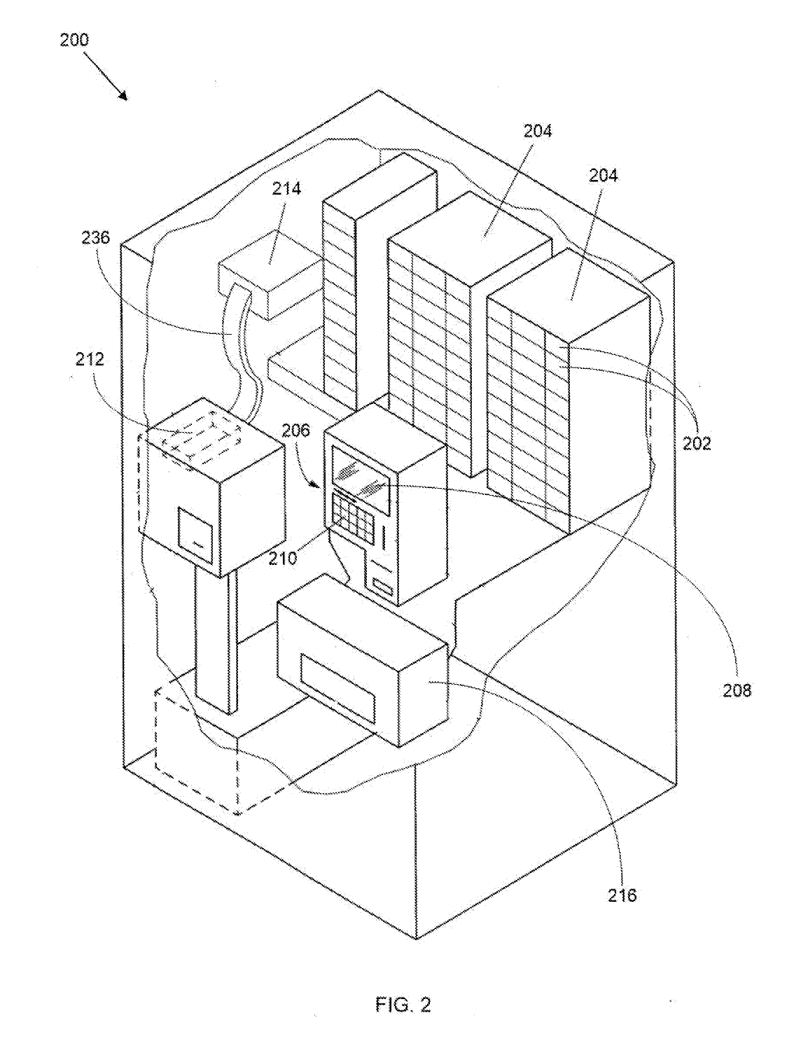

The method 100 may further comprise a Step 104 of integrating the power charger 202 into at least one vending machine 200, the at least one vending machine 200 having a charging portion 216 and a fee collection portion 206. As shown in FIG. 2, the vending machine 200 is sufficiently sized and dimensioned to hold a plurality of power chargers 202. The vending machine 200 may include a display screen 208 for displaying payment options and the types of power chargers 202 available. An access key 210 enables the renter to make a desired selections and pay the fees. The vending machine 200 may also have a receiver/transponder 212 for communicating through radio frequency to a central processor 214 and other vending machines 200. The vending machine 200 may further include an internal circuitry 236 for controlling the communication, collecting fees, and dispensing of the power charger 202.

In some embodiments, the vending machine 200 automatically recharges the power charger 202 while the power charger 202 connector is coupled thereto. The charging portion 216 serves to recharge the power charger 202 until the power charger 202 is accessed by the renter. The charging portion 216 includes a vending machine connector. The vending machine connector mates with the power charger connector 222 to recharge the power charger 202 when not being rented. The charging portion 216 of the vending machine 200 in turn, may receive power from an external power source.

In some embodiments, the fee collection portion 206 of the vending machine 200 is defined by a bill changer, a coin slot, a credit card reader, and a radio frequency receiver/transponder 212 for communicating with the central processor 214. The fee collection portion 206 is configured to receive cash through a cash and coin tray, or read a credit card for processing through a card reader. The renter may access the fee collection portion 206 through the access key, or remotely through a smart phone having a software application for payments.

A Step 106 includes positioning the at least one vending machine 200 in at least one public site. The at least one vending machine 200 may be integrated into public sites where the power source for the communication device 232 is susceptible to depletion and recharging stations are difficult to find. These public sites may include, without limitation, airports, bus stations, hotels, restaurants, grocery stores, parks, camp grounds, and sites that host public events. In some embodiments, the method 100 may utilize more than one vending machine 200 at more than one site.

In some embodiments, a plurality of vending machines 200 are operatively connected together, such that the power charger 202 can be rented by the user at a first vending machine, and then returned or replaced at a second vending machine. This is possible because the first and second vending machines are in communication with each other and a central processor 214 that records the rental information, such as the renter's contact information, payment method, time of rental, and time of return. This multisite renting capacity can especially be useful for travelers moving between airports and train stations.

In some embodiments, a Step 108 comprises charging the power charger 202 with the charging portion 216 of the at least one vending machine 200. The vending machine 200 automatically recharges the power charger 202 when the vending machine connector is coupled to the power charger connector 222. In one embodiment, the renter detaches the power charger connector 222 from the vending machine connector to access the power charger 202, and upon returning the power charger 202, mates the power charger connector 222 to the vending machine 200 connector. However, in other embodiments, the power charger 202 drops into a dispensing tray for the renter to access.

A Step 110 includes receiving an access fee through the fee collection portion 206 of the at least one vending machine 200, wherein the access fee is received prior to accessing the power charger 202. In some embodiments, the renter may rent the power charger 202 for a predetermined period and then return the depleted power charger 202 at any point after charging the communication device 232. The renter pays an access fee for initially accessing the power charger 202. The power charger 202 may be configured to provide multiple charges to the communication device 232. In one alternative embodiment, the renter registers with a central processor 214 prior to accessing the power charger 202. After registering, the renter can simply activate an account number on the vending machine 200 to access the power charger 202. The central processor 214 recognizes the renter form the account information and automatically deducts the appropriate fees from the renter's account.

In some embodiments, a Step 112 may include dispensing the power charger 202 from the at least one vending machine 200. The dispensing of the power charger 202 may be accomplished in multiple ways. In one embodiment, the vending machine connector is decoupled from the power charger connector 222. Each connector 222 may have electrical poles that interact to carry electrical power therebetween. A slight pulling force disengages the connectors 222 from each other.

In another embodiment, the power charger 202 may be stored in a power charger container 204 having a plurality of slots that face the renter, and are visible through a transparent panel. Upon receiving the access fee, the appropriate power charger 202 is mechanically pushed out of the slot and falls to a dispensing tray at a lower end of the vending machine 200. The renter can then reach into the dispensing tray to access the power charger 202. A return slot provides a space for dropping off the power charger 202 after use. However, in other embodiments, any dispensing mechanism known in the art may be used.

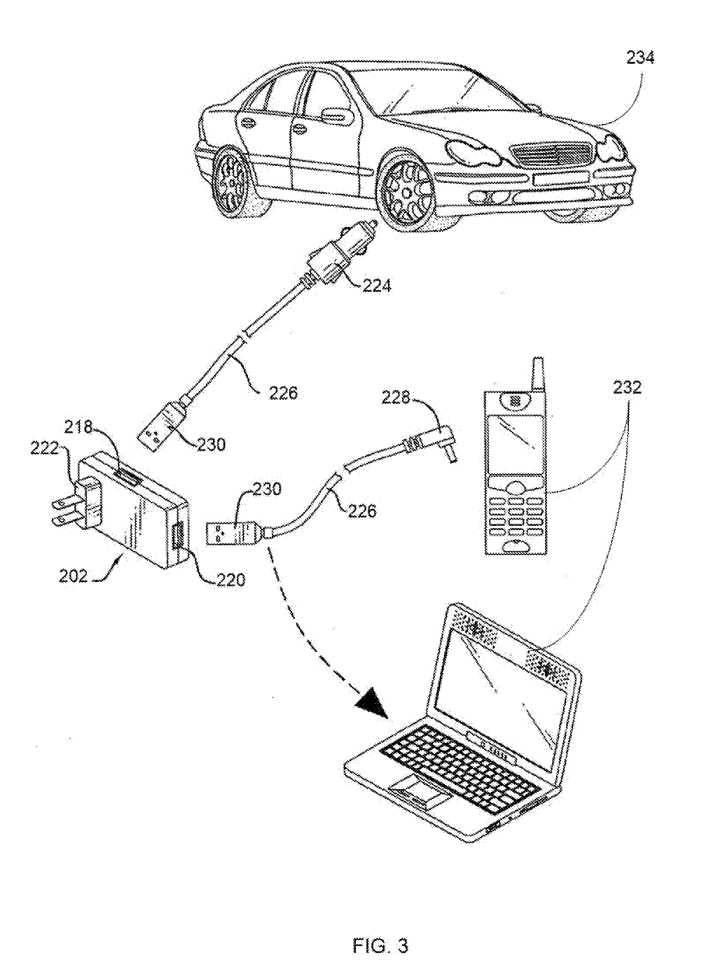

A Step 114 comprises adapting the power charger 202 to provide at least one charge to different types of communication devices 232. The power charger 202 may include, without limitation, a USB port 218, a micro USB port 220, a power level indicator, and a tethering cable 226 having multiple heads for mating with the wide variety of device ports/plugs and device cables commonly found in communication devices 232. In one embodiment, the plurality of ports from the power charger 202 include at least one member selected from the group consisting of: a USB port 218, a micro USB port 220, an output 2.1 Amp port, an output 1 Amp port, a pronged electrical plug, a car jack 224, a phone jack 228, a USB plug 230, and a power charger connector 222 (FIG. 3). However, in other embodiments, any electrical connecting medium that carries electrical power may be used.

In some embodiments, a Step 116 comprises returning the power charger 202 to the at least one vending machine 200 for recharging and additional access. The power charger 202 may have a power charger connector 222 for coupling to a vending machine connector on the vending machine 200. The renter detaches the power charger connector 222 from the vending machine connector to rent the power charger 202, and, upon returning the power charger 202, mates the power charger connector 222 to the vending machine connector. The charging portion 216 of the vending machine 200 automatically recharges the power charger 202 while the power charger connector 222 is coupled thereto.

A Step 118 includes receiving a periodic fee through the fee collection portion 206 of the at least one vending machine 200, wherein the periodic fee is commensurate with a period of time that the power charger 202 was accessed. The periodic fee accumulates, whereas the aforementioned access fee is a one-time fee. For example, a power charger 202 that has provided multiple charges to the communication device 232 is depleted after four days. After the power charger 202 is depleted, the renter either returns the depleted power charger 202 to the vending machine 200 or accesses a fresh power charger 202. Alternatively, the renter may simply terminate the rental by returning the power charger 202 to any vending machine 200. In either case, the renter pays a periodic fee for each interval of time (day) that the power charger 202 is retained. However, if the renter requires a replacement power charger 202, the renter must pay an access fee each time an additional power charger 202 is rented.

In some embodiments, a deposit for the power charger 202 may also be required. The renter may pay the fees with cash, credit card, or wire transfer, or any known method of payment for a vending machine 200. In one alternative embodiment, the renter may have an account with the vending machine 200, whereby the renter simply activates the account to receive the power charger 202. And the vending machine 200, in communication with the central processor 214, deducts form the renter's account accordingly.

A final Step 120 includes communicating between the at least one vending machine 200 and a central processor 214 about the access fee, the periodic fee, and the period of time that the power charger 202 is accessed. In one embodiment, the central processor 214 communicates with vending machines 200 located at different sites and performs more sophisticated functions, generally not possible with a vending machine 200, such as data storage, billing, marketing, and inventory control. In one alternative embodiment, the renter registers to open an account with the central processor 214. Upon needing a power charger 202, the renter simply activates the account to receive the power charger 202 from the vending machine 200. And the vending machine 200, in communication with the central processor 214, deducts from the renter's account accordingly.

The communication between the at least one vending machine 200 and the central processor 214 can also include calculating the access fee and the periodic fee. The communication also involves coordinating multiple vending machines 200, such as a first vending machine where the power charger 202 was accessed and a second vending machine 200 where the power charger 202 was returned. This enables the renter to pick up and drop off the power charger 202 at different sites.

For example, a first vending machine at a first airport, and a second vending machine at a second airport communicate through radio frequency or through satellite signals to coordinate the access fee and the periodic fee for a power charger 202 that was accessed and returned to each respective vending machine. The central processor 214 records the communication for billing of the access fee at the first vending machine and the periodic fee at the second vending machine. The central processor 214 also monitors inventory to compensate for the unsymmetrical access and return of power chargers 202. The central processor 214 may be located on a central vending machine that communicates with a plurality of subordinate vending machines; or the central processor 214 may be located remotely. The central processor 214 may include, without limitation, a central vending machine containing the central processor 214, a remote server, a database, a computer, a cloud network, and a call center. The central processor 214 may be used for storing information about the renter, including, personal information and credit card information. The central processor 214 can also provide marketing functions by emailing the renter with promotions and general renter information.

In an embodiment the vending machine shall be a power station that is controlled by an establishment.

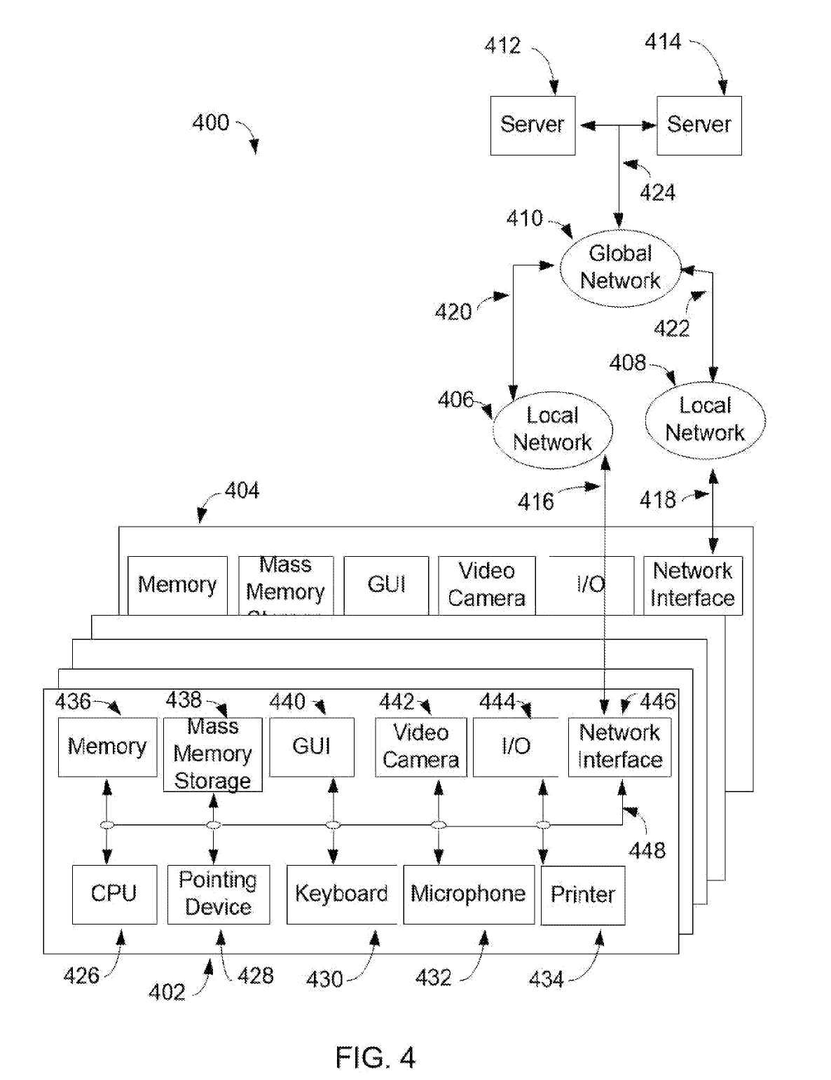

FIG. 4 is a block diagram depicting an exemplary client/server system which may be used by an exemplary web-enabled/networked embodiment of the present invention.

A communication system 400 includes a multiplicity of clients with a sampling of clients denoted as a client 402 and a client 404, a multiplicity of local networks with a sampling of networks denoted as a local network 406 and a local network 408, a global network 410 and a multiplicity of servers with a sampling of servers denoted as a server 412 and a server 414.

Client 402 may communicate bi-directionally with local network 406 via a communication channel 416. Client 404 may communicate bi-directionally with local network 408 via a communication channel 418. Local network 406 may communicate bi-directionally with global network 410 via a communication channel 420. Local network 408 may communicate bi-directionally with global network 410 via a communication channel 422. Global network 410 may communicate bi-directionally with server 412 and server 414 via a communication channel 424. Server 412 and server 414 may communicate bi-directionally with each other via communication channel 424. Furthermore, clients 402, 404, local networks 406, 408, global network 410 and servers 412, 414 may each communicate bi-directionally with each other.

In one embodiment, global network 410 may operate as the Internet. It will be understood by those skilled in the art that communication system 400 may take many different forms. Non-limiting examples of forms for communication system 400 include local area networks (LANs), wide area networks (WANs), wired telephone networks, wireless networks, or any other network supporting data communication between respective entities.

Clients 402 and 404 may take many different forms. Non-limiting examples of clients 402 and 404 include personal computers, personal digital assistants (PDAs), cellular phones and smartphones.

Client 402 includes a CPU 426, a pointing device 428, a keyboard 430, a microphone 432, a printer 434, a memory 436, a mass memory storage 438, a GUI 440, a video camera 442, an input/output interface 444 and a network interface 446.

CPU 426, pointing device 428, keyboard 430, microphone 432, printer 434, memory 436, mass memory storage 438, GUI 440, video camera 442, input/output interface 444 and network interface 446 may communicate in a unidirectional manner or a bi-directional manner with each other via a communication channel 448. Communication channel 448 may be configured as a single communication channel or a multiplicity of communication channels.

CPU 426 may be comprised of a single processor or multiple processors. CPU 426 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 436 is used typically to transfer data and instructions to CPU 426 in a bi-directional manner. Memory 436, as discussed previously, may include any suitable computer-readable media, intended for data storage, such as those described above excluding any wired or wireless transmissions unless specifically noted. Mass memory storage 438 may also be coupled bi-directionally to CPU 426 and provides additional data storage capacity and may include any of the computer-readable media described above. Mass memory storage 438 may be used to store programs, data and the like and is typically a secondary storage medium such as a hard disk. It will be appreciated that the information retained within mass memory storage 438, may, in appropriate cases, be incorporated in standard fashion as part of memory 436 as virtual memory.

CPU 426 may be coupled to GUI 440. GUI 440 enables a user to view the operation of computer operating system and software. CPU 426 may be coupled to pointing device 428. Non-limiting examples of pointing device 428 include computer mouse, trackball and touchpad. Pointing device 428 enables a user with the capability to maneuver a computer cursor about the viewing area of GUI 440 and select areas or features in the viewing area of GUI 440. CPU 426 may be coupled to keyboard 430. Keyboard 430 enables a user with the capability to input alphanumeric textual information to CPU 426. CPU 426 may be coupled to microphone 432. Microphone 432 enables audio produced by a user to be recorded, processed and communicated by CPU 426. CPU 426 may be connected to printer 434. Printer 434 enables a user with the capability to print information to a sheet of paper. CPU 426 may be connected to video camera 442. Video camera 442 enables video produced or captured by user to be recorded, processed and communicated by CPU 426.

CPU 426 may also be coupled to input/output interface 444 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 426 optionally may be coupled to network interface 446 which enables communication with an external device such as a database or a computer or telecommunications or internet network using an external connection shown generally as communication channel 416, which may be implemented as a hardwired or wireless communications link using suitable conventional technologies. With such a connection, CPU 426 might receive information from the network, or might output information to a network in the course of performing the method steps described in the teachings of the present invention.

While the inventor's above description contains many specificities, these should not be construed as limitations on the scope, but rather as an exemplification of several preferred embodiments thereof. Many other variations are possible. For example, the voltage or current input/output of the control unit may vary without affecting the objective of the system. Accordingly, the scope should be determined not by the embodiments illustrated, but by the appended claims and their legal equivalents.

What is claimed is:

1. A method for renting a portable and universal power charger from a vending machine, the method comprising:
providing a power charger, the power charger configured to provide at least one charge to a communication device;
integrating the power charger into at least one vending machine, the at least one vending machine having a charging portion and a fee collection portion;
positioning the at least one vending machine in at least one public site;
charging the power charger with the charging portion of the at least one vending machine;
receiving an access fee through the fee collection portion of the at least one vending machine, wherein the access fee is received prior to accessing the power charger;
dispensing the power charger from the at least one vending machine;
adapting the power charger to provide at least one charge to different types of communication devices;
returning the power charger to the at least one vending machine for recharging and additional access;
receiving a periodic fee through the fee collection portion of the at least one vending machine, wherein the periodic fee is commensurate with a period of time that the power charger was accessed; and
communicating between the at least one vending machine and a central processor about the access fee, the periodic fee, and the period of time that the power charger is accessed.

2. The method of claim 1, wherein the power charger is defined by a plurality of ports, a charge capacity, a cable, and a power level indicator.

3. The method of claim 2, wherein the step of adapting the power charger to provide at least one charge to different types of communication devices is operable through the plurality of ports.

4. The method of claim 3, wherein the plurality of ports include at least one member selected from the group consisting of: a USB port, a micro USB port, an output 2.1 Amp port, an output 1 Amp port, a pronged electrical plug, a car jack, a phone jack, a USB plug, and a power charger connector.

5. The method of claim 4, wherein the charging portion of the at least one vending machine is defined by a battery and a power charger connector.

6. The method of claim 5, wherein the step of dispensing the power charger from the at least one vending machine, further includes disengaging the vending machine connector from the power charger connector.

7. The method of claim 6, wherein the power charger has a charge capacity of at least 10,000 milliamps per hour.

8. The method of claim 7, wherein the method further includes a step of registering to access the power charger.

9. The method of claim 8, wherein the step of registering, further comprises receiving personal information and credit card information.

10. The method of claim 1, wherein the fee collection portion of the at least one vending machine is defined by a bill changer, a coin slot, a credit card reader, and a radio frequency transponder and/or receiver for communication with the central processor.

11. The method of claim 1, wherein the step of receiving an access fee through the fee collection portion of the at least one vending machine, further includes receiving cash through a cash and coin tray, or reading a credit card for processing through a card reader.

12. The method of claim 1, wherein the step of communicating between the at least one vending machine and a central processor about the access fee, the periodic fee, and the period of time, further includes calculating the access fee and the periodic fee.

13. The method of claim 1, wherein the central processor includes at least one member selected from the group consisting of: a central vending machine having the central processor, a server, a database, a computer, a cloud network, and a call center.

14. The method of claim 1, wherein the step of communicating between the at least one vending machine and a central processor about the access fee, the periodic fee, and the period of time that the power charger was accessed, further includes a first vending machine and a second vending machine communicating to coordinate the access fee and the periodic fee.

15. The method of claim 1, wherein the vending machine is a power station that is controlled by an establishment.

16. The method of claim 1, wherein the at least one public site includes at least one member selected from the group consisting of: airports, bus stations, hotels, restaurants, grocery stores, parks, camp grounds, and sites that host public events.

17. A method for renting a portable and universal power charger from a vending machine, the method comprising:
providing a power charger, the power charger configured to provide at least one charge to a communication device;
integrating the power charger into at least one vending machine;
charging the power charger in the at least one vending machine;
receiving an access fee, wherein the access fee is received prior to accessing the power charger;
dispensing the power charger from the at least one vending machine;
adapting the power charger to provide at least one charge to different types of communication devices;
returning the power charger to the at least one vending machine for recharging and additional access; and
receiving a periodic fee, wherein the periodic fee is commensurate with a period of time that the power charger is accessed.

18. The method of claim 17, wherein the power charger is defined by a plurality of ports, a charge capacity, a cable, and a power level indicator.

19. The method of claim 17, further including the step of communicating between the at least one vending machine and a central processor about the access fee, the periodic fee, and the period of time that the power charger is accessed

20. A method for renting a portable and universal power charger from a vending machine, the method comprising:
providing a power charger, the power charger configured to provide at least one charge to a mobile phone, the power charger defined by a plurality of ports, a charge capacity, a cable, and a power level indicator;
integrating the power charger into at least one vending machine, the at least one vending machine having a charging portion and a fee collection portion;
positioning the at least one vending machine in at least one public site;
charging the power charger with the charging portion of the at least one vending machine;
registering a renter to access the power charger, wherein the registration includes receiving personal information and credit card information from the renter;
receiving an access fee from the renter through the fee collection portion of the at least one vending machine, wherein the access fee is received from the renter prior to accessing the power charger;
dispensing the power charger to the renter from the at least one vending machine;
adapting the power charger to provide at least one charge to different types of mobile phones;
returning the power charger, by the renter, to the at least one vending machine for recharging and additional access;
receiving a periodic fee through the fee collection portion of the at least one vending machine, wherein the periodic fee is commensurate with a period of time that the power charger is accessed; and
communicating between the at least one vending machine and a central processor about the access fee, the periodic fee, and the period of time that the power charger was accessed.
